(19) United States
(12) Patent Application Publication
(10) Pub. No.: US 2016/0042405 A1
(43) Pub. Date: Feb. 11, 2016

(54) Providing a Grace Period for Payment of a Delinquent Advertising Account

(71) Applicant: Facebook, Inc., Menlo Park, CA (US)

(72) Inventors: Sharon Zeng, Mountain View, CA (US); Pratap Venkataram Prabhu, Sunnyvale, CA (US); Marius Mircea Lazer, Palo Alto, CA (US); Aaron Patrick O'Brien, Austin, TX (US); Franklin Sarkett, Austin, TX (US); Leonid Dubinsky, Redmond, WA (US); Erica L. Sanders, Seattle, WA (US); Leslie Kathleen Smith, Austin, TX (US)

(21) Appl. No.: 14/451,574

(22) Filed: Aug. 5, 2014

(51) Int. Cl. G06Q 30/02

(52) U.S. Cl. CPC G06Q 30/0273; G06Q 40/025

(57) ABSTRACT

Methods and systems are described for identifying a likelihood that a client will provide payment for an overdue balance associated with the client's account and ranting a grace period to the client in which to provide the payment. This permits a client to provide payment for an overdue balance that may have been unintentional without an interruption of the services rendered to the client. Factors used to determine whether to grant the grace period include financial characteristics of the client's account. In the example of an advertiser using a social networking system to serve ads, social engagement of the advertiser can also be used to determine whether to grant a grace period.

### BACKGROUND

Embodiments of the present disclosure relate generally to advertising systems, and more particularly to determining whether to provide a grace period to an advertiser for payment of an overdue balance of a delinquent advertising account.

On-line advertising provides advertisers with a convenient, on-line user interface to create and manage advertisements and advertising campaigns, and provides advertising providers (such as social networking systems) a convenient system for managing advertising accounts. For example, an advertiser purchases advertisements, targeting data, advertisement delivery options, or combinations thereof from the advertising provider using a user interface. The advertising provider provides an account balance to the advertiser and facilitates payment for the provided advertising services also through the user interface.

In some cases, advertisers fail to promptly pay for advertisements delivered by the advertising provider. While this can be intentional, in some instances the non-payment of an account balance, and the resulting delinquency of the account, is unintentional. Traditionally in response to an overdue account balance, the advertising provider would suspend the advertiser's campaign until the account is made current. This is detrimental to the advertiser because advertisements are no longer served, thus reducing the exposure of the advertised product to intended viewers. In more extreme examples, the disruption can be a significant problem if the advertising campaign is coordinated with a product to be released on a specified date or if a product release is coordinated with some other date-specific event (e.g., a sporting good to be released shortly before a significant and independently publicized sporting event). In another example, advertising campaigns designed to progressively build user engagement with a series of different advertisements delivered in a sequence over a period of time and targeted to a specific group of users risk losing the momentum because of the interruption in the timing and sequence of advertisements.

A suspension of advertising services is also detrimental to adverting providers. For unintentional account delinquencies, suspension of a delinquent account can damage a relationship with an advertiser that is typically in good standing and/or an advertiser that has a long relationship with the advertiser provider. Furthermore, when advertisements are no longer served due to an account suspension, the advertising provider risks losing advertising revenue that cannot be regained.

Because the failure to pay an account balance may be unintentional, it would be beneficial to determine whether suspension of the account can be delayed.

### SUMMARY

An advertising provider charges advertisers for display of advertisements periodically and/or when a threshold account balance is reached. If the advertiser's selected payment method is declined, rather than suspending the advertiser's account (which prevents the advertiser from creating new ads or displaying current ads and also results in revenue loss for the advertising provider), an advertising system can provide the advertiser a grace period for payment. This grace period is applied for advertisers that have unintentionally failed to pay or typically pay shortly after a deadline. The system predicts which advertisers fall into this category of being likely to pay their overdue account balance within a short period. Such a “creditworthy” advertiser is given a limited grace period in which to pay the overdue account balance and during which advertising services are still provided by the advertising provider. This includes preserving the ability of the advertiser to control the account and to continue to serve advertisements to users. When an account in a grace period is paid up (i.e., rendered “current”), it is moved out of the grace period and into a normal mode. However, if the account still includes an overdue balance (i.e., is “delinquent”) after expiration of the grace period, the account is suspended.

Several factors are used to determine whether to grant the grace period. In some embodiments, these factors can also be used to determine a duration of the grace period that is granted. In other embodiments, the grace period is a fixed period. For example, the system can consider whether funds were received from the advertiser in a time period preceding a declined payment transaction. Generally, the more recently an advertiser has paid for services rendered prior to the declined payment transaction the more likely the advertiser is to pay an overdue balance. Another factor that can be used is the amount of funds that have been received from the advertiser over a period preceding a declined payment transaction. In some embodiments, the larger the amount of funds paid for services rendered prior to the declined payment transaction, the more likely the advertiser is to pay an overdue balance. In other examples, a combination of these factors is used.

For examples in which a social networking system provides advertising services to an advertiser, social factors can also be used to determine whether to grant a grace period (or to determine the duration of a grace period once granted). One social factor that can be considered is user engagement with content related to the advertiser. Generally, the more that social networking system users engage with the advertisements, the more likely the advertiser is spending time creating good advertisements, and hence is an advertiser that will pay an overdue balance. For example, the number of conversions, clicks, and endorsements of advertisements of the advertiser can be used to determine whether and how long to grant a grace period. Another social factor is the presence of other types of social networking system objects associated with the advertiser, its advertisements, and/or any related user interactions with the objects. For example, determining whether advertisements of the advertiser are linked to a landing page of an advertiser can be indicative of whether an advertiser will pay an overdue balance.

### BRIEF DESCRIPTION OF THE DRAWINGS

FIG. 1 is a block diagram of a system environment in which a social networking system operates, in an embodiment.

FIG. 2 is a block diagram of a social networking system, in an embodiment.

FIG. 3 is a method flow diagram for determining whether to grant a grace period to a delinquent advertising account, in an embodiment.

FIG. 4 is a method flow diagram for determining whether to grant a grace period by applying creditworthiness factors and social factors, in an embodiment.

FIG. 5 is a bar graph depicting empirical payment data used to determine whether to grant a grace period as a function of overdue balance, in an embodiment.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### System Architecture

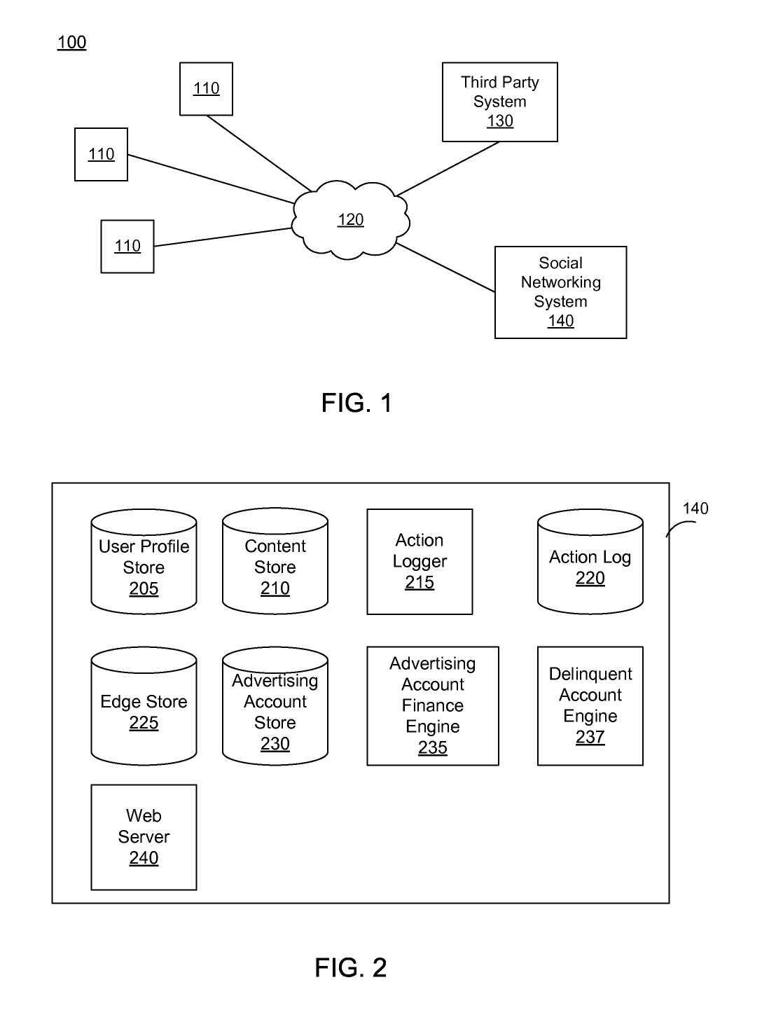

FIG. 1 is a high level block diagram of a system environment 100 for a social networking system 140. The system environment 100 shown by FIG. 1 comprises one or more client devices 110, a network 120, one or more third-party systems 130, and the social networking system 140. In alternative configurations, different and/or additional components may be included in the system environment 100. The embodiments described herein can be adapted to online systems that are not social networking systems, including any advertising system.

The client devices 110 are one or more computing devices capable of receiving user input as well as transmitting and/or receiving data via the network 120. In one embodiment, a client device 110 is a conventional computer system, such as a desktop or laptop computer. Alternatively, a client device 110 may be a device having computer functionality, such as a personal digital assistant (PDA), a mobile telephone, a smartphone or another suitable device. A client device 110 is configured to communicate via the network 120. In one embodiment, a client device 110 executes an application allowing a user of the client device 110 to interact with the social networking system 140. For example, a client device 110 executes a browser application to enable interaction between the client device 110 and the social networking system 140 via the network 120. In another embodiment, a client device 110 interacts with the social networking system 140 through an application programming interface (API) running on a native operating system of the client device 110, such as IOS® or ANDROID™.

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

One or more third party systems 130 may be coupled to the network 120 for communicating with the social networking system 140, which is further described below in conjunction with FIG. 2. In one embodiment, a third party system 130 is an application provider communicating information describing applications for execution by a client device 110 or communicating data to client devices 110 for use by an application executing on the client device. In other embodiments, a third party system 130 provides content or other information for presentation via a client device 110. A third party website 130 may also communicate information to the social networking system 140, such as advertisements, content, or information about an application provided by the third party website 130.

FIG. 2 is an example block diagram of an architecture of the social networking system 140. The social networking system 140 shown in FIG. 2 includes a user profile store 205, a content store 210, an action logger 215, an action log 220, an edge store 225, an advertising account store 230, an advertising account finance engine 235, a delinquent account engine 237, and a web server 240. In other embodiments, the social networking system 140 may include additional, fewer, or different components for various applications. Conventional components such as network interfaces, security functions, load balancers, failover servers, management and network operations consoles, and the like are not shown so as to not obscure the details of the system architecture.

Each user of the social networking system 140 is associated with a user profile, which is stored in the user profile store 205. A user profile includes declarative information about the user that was explicitly shared by the user and may also include profile information inferred by the social networking system 140. In one embodiment, a user profile includes multiple data fields, each describing one or more attributes of the corresponding user of the social networking system 140. Examples of information stored in a user profile include biographic, demographic, and other types of descriptive information, such as work experience, educational history, gender, hobbies or preferences, location and the like. A user profile may also store other information provided by the user, for example, images or videos. In certain embodiments, images of users may be tagged with identification information of users of the social networking system 140 displayed in an image. A user profile in the user profile store 205 may also maintain references to actions by the corresponding user performed on content items in the content store 210 and stored in the action log 220.

While user profiles in the user profile store 205 are frequently associated with individuals, allowing individuals to interact with each other via the social networking system 140, user profiles may also be stored for entities such as businesses or organizations. This allows an entity to establish a presence on the social networking system 140 for connecting and exchanging content with other social networking system users. The entity may post information about itself, about its products or provide other information to users of the social networking system using a brand page associated with the entity's user profile. Other users of the social networking system may connect to the brand page (referred to below as a “landing page”) to receive information posted to the brand page or to receive information from the brand page. A user profile associated with the brand page may include information about the entity itself, providing users with background or informational data about the entity.

The content store 210 stores objects that each represent various types of content. Examples of content represented by an object include a page post, a status update, a photograph, a video, a link, a shared content item, a gaming application achievement, a check-in event at a local business, a brand page, or any other type of content. Social networking system users may create objects stored by the content store 210, such as status updates, photos tagged by users to be associated with other objects in the social networking system, events, groups or applications. In some embodiments, objects are received from third-party applications or third-party applications separate from the social networking system 140. In one embodiment, objects in the content store 210 represent single pieces of content, or content “items.” Hence, users of the social networking system 140 are encouraged to communicate with each other by posting text and content items of various types of media through various communication channels. This increases the amount of interaction of users with each other and increases the frequency with which users interact within the social networking system 140.

The action logger 215 receives communications about user actions internal to and/or external to the social networking system 140, populating the action log 220 with information about user actions. Examples of actions include adding a connection to another user, sending a message to another user, uploading an image, reading a message from another user, viewing content associated with another user, attending an event posted by another user, among others. In addition, a number of actions may involve an object and one or more particular users, so these actions are associated with those users as well and stored in the action log 220.

The action log 220 may be used by the social networking system 140 to track user actions on the social networking system 140, as well as actions on third party systems 130 that communicate information to the social networking system 140. Users may interact with various objects on the social networking system 140, and information describing these interactions are stored in the action log 210. Examples of interactions with objects include: commenting on posts, sharing links, and checking-in to physical locations via a mobile device, accessing content items, and any other interactions. Additional examples of interactions with objects on the social networking system 140 that are included in the action log 220 include: commenting on a photo album, communicating with a user, establishing a connection with an object, joining an event to a calendar, joining a group, creating an event, authorizing an application, using an application, expressing a preference for an object (“liking” the object) and engaging in a transaction. Additionally, the action log 220 may record a user's interactions with advertisements on the social networking system 140 as well as with other applications operating on the social networking system 140. In some embodiments, data from the action log 220 is used to infer interests or preferences of a user, augmenting the interests included in the user's user profile and allowing a more complete understanding of user preferences.

The action log 220 may also store user actions taken on a third party system 130, such as an external website, and communicated to the social networking system 140. For example, an e-commerce website that primarily sells sporting equipment at bargain prices may recognize a user of a social networking system 140 through a social plug-in enabling the e-commerce website to identify the user of the social networking system 140. Because users of the social networking system 140 are uniquely identifiable, e-commerce websites, such as this sporting equipment retailer, may communicate information about a user's actions outside of the social networking system 140 to the social networking system 140 for association with the user. Hence, the action log 220 may record information about actions users perform on a third party system 130, including webpage viewing histories, advertisements that were engaged, purchases made, and other patterns from shopping and buying.

In one embodiment, an edge store 225 stores information describing connections between users and other objects on the social networking system 140 as edges. Some edges may be defined by users, allowing users to specify their relationships with other users. For example, users may generate edges with other users that parallel the users' real-life relationships, such as friends, co-workers, partners, and so forth. Other edges are generated when users interact with objects in the social networking system 140, such as expressing interest in a page on the social networking system, sharing a link with other users of the social networking system, and commenting on posts made by other users of the social networking system.

In one embodiment, an edge may include various features each representing characteristics of interactions between users, interactions between users and object, or interactions between objects. For example, features included in an edge describe rate of interaction between two users, how recently two users have interacted with each other, the rate or amount of information retrieved by one user about an object, or the number and types of comments posted by a user about an object. The features may also represent information describing a particular object or user. For example, a feature may represent the level of interest that a user has in a particular topic, the rate at which the user logs into the social networking system 140, or information describing demographic information about a user. Each feature may be associated with a source object or user, a target object or user, and a feature value. A feature may be specified as an expression based on values describing the source object or user, the target object or user, or interactions between the source object or user and target object or user; hence, an edge may be represented as one or more feature expressions.

The edge store 225 also stores information about edges, such as affinity scores for objects, interests, and other users. Affinity scores, or “affinities,” may be computed by the social networking system 140 over time to approximate a user's affinity for an object, interest, and other users in the social networking system 140 based on the actions performed by the user. A user's affinity may be computed by the social networking system 140 over time to approximate a user's affinity for an object, interest, and other users in the social networking system 140 based on the actions performed by the user. Computation of affinity is further described in U.S. patent application Ser. No. 12/978,265, filed on Dec. 23, 2010, U.S. patent application Ser. No. 13/690,254, filed on Nov. 30, 2012, U.S. patent application Ser. No. 13/689,969, filed on Nov. 30, 2012, and U.S. patent application Ser. No. 13/690,088, filed on Nov. 30, 2012, each of which is hereby incorporated by reference in its entirety. Multiple interactions between a user and a specific object may be stored as a single edge in the edge store 225, in one embodiment. Alternatively, each interaction between a user and a specific object is stored as a separate edge. In some embodiments, connections between users may be stored in the user profile store 205, or the user profile store 205 may access the edge store 225 to determine connections between users.

The advertising account store 230 stores information related to advertisers, advertisements themselves, and advertising campaigns. The advertising account store 230 stores advertisements and the information related to the distribution of the advertisements to serve advertisements to users of the social networking system, and manage advertisements and advertising campaigns. For example, information related to advertisers stored in the advertising account store 230 includes an individual or corporate identity (and a corresponding identifier) of the advertiser, a description of products or product lines of the advertiser, and a description of a relationship between the advertiser and the social networking system (e.g., size and longevity of account). Information of the advertising account store 230 related to the advertisements themselves includes, but is not limited to, the content of an advertisement provided to the social networking system 140 by an advertiser. Similarly, an advertising request from an advertiser is stored in the advertising account store 230. An advertising request is used to generate the advertisement and target it appropriately within the social networking system 140. For example, the advertising request identifies social networking system generated content to be included in the advertisement, targeting criteria, and advertisement type (e.g., a banner advertisement, a “social advertisement” as described in U.S. patent application Ser. No. 12/193,702, and incorporated by reference in its entirety). Information stored in the advertising account store 230 related to an advertising campaign includes, but is not limited to, the number of advertisements to be served, the time during a day, week, and/or month advertisements are to be served, and the cost model (e.g., cost per click, cost per impression, cost per conversion) of the advertisements.

The advertising account store 230 also provides information to an advertiser for managing an advertising account. For example, an advertiser accesses the social networking system 140 through its user or business account. A user interface is presented that, by connection to the advertising account store 230, allows the advertiser to manage existing advertisements and campaigns, review performance data related to existing advertisements and campaigns, request new advertisements, and review account status. The account status includes an instantaneous account balance for advertising services rendered, a payment due date, whether the account is delinquent, whether a grace period has been instituted, and optionally the duration of the grace period.

The advertising account finance engine 235 accesses the current outstanding account balance (as stored in the advertising account store 230) associated with an advertiser's account and also accesses payment information. This payment information includes, for example, a credit card number associated with an advertiser, a bank transfer number and authorization, or other financial account information used to access funds to pay for advertising. The advertising account finance engine 235 also periodically executes a charge using advertiser's payment information so that payment is provided by the advertiser for the advertising services rendered by the social networking system 140. The charge can be executed at any frequency agreed to by the advertiser and by the social networking system 140. In one example the frequency is monthly. The advertising account finance engine 235 optionally includes additional security protections to prevent unauthorized access to sensitive financial information of the advertiser.

The delinquent account engine 237 identifies advertising accounts for which a payment transaction executed by the advertising account finance engine 235 has been declined (e.g., a charge to a credit card) or has otherwise failed. Upon identifying such an account, the delinquent account engine 237 determines whether or not to grant a grace period to the advertiser. If granted, the delinquent account engine 237 can, in some embodiments, determine a duration of the grace period and inform the advertiser of the delinquent status, the grace period, and the grace period duration. For situations in which the account is not granted a grace period, the delinquent account engine 237 communicates with the system 140 to suspend the account of the advertiser, thus preventing any more advertisements from being served to users.

The web server 240 links the social networking system 140 via the network 120 to the one or more client devices 110, as well as to the one or more third party systems 130. The web server 140 serves web pages, as well as other web-related content, such as JAVA®, FLASH®, XML and so forth. The web server 240 may receive and route messages between the social networking system 140 and the client device 110, for example, instant messages, queued messages (e.g., email), text messages, short message service (SMS) messages, or messages sent using any other suitable messaging technique. A user may send a request to the web server 240 to upload information (e.g., images or videos) that are stored in the content store 210. Additionally, the web server 240 may provide application programming interface (API) functionality to send data directly to native client device operating systems, such as IOS®, ANDROID™, WEBOS® or RIM®.

### Determining Whether to Grant a Grace Period

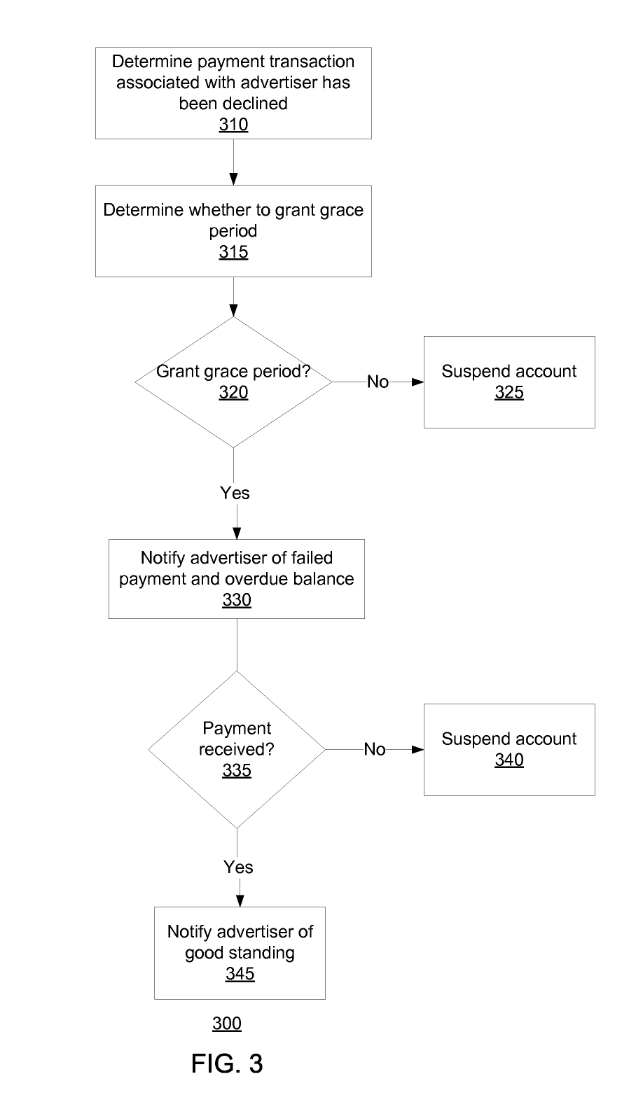

FIG. 3 is a method flow diagram for a method 300 for determining whether to grant a grace period to a delinquent advertising account, in an embodiment. While the example presented below is in the context of advertising on a social networking system, embodiments described herein are applicable to any advertising system or any system in which accounts accrue balances that are paid periodically. As described above, benefits of granting a grace period to an overdue account include avoiding the loss of revenue for clients that have unintentionally failed to pay a balance but would have normally paid. Another benefit is maintaining a working relationship with a client by continuing to provide uninterrupted service even though the account balance is overdue. This allows the advertiser to continue to execute its advertising campaign (and meet any required schedule such as advertising in advance of a new product release or advertising a product prior to a predetermined date).

The method 300 begins upon a determination 310 that a payment transaction associated with an advertiser has been declined. One example of such a declined transaction is a charge to a credit card number (and optionally other information used to successfully charge the account associated with the credit card) provided to the social networking system for periodic charging of the advertising account balance. Other types of payment transactions are possible (such as bank transfers, purchase orders, and others) but credit card accounts are used in this example for clarity of explanation.

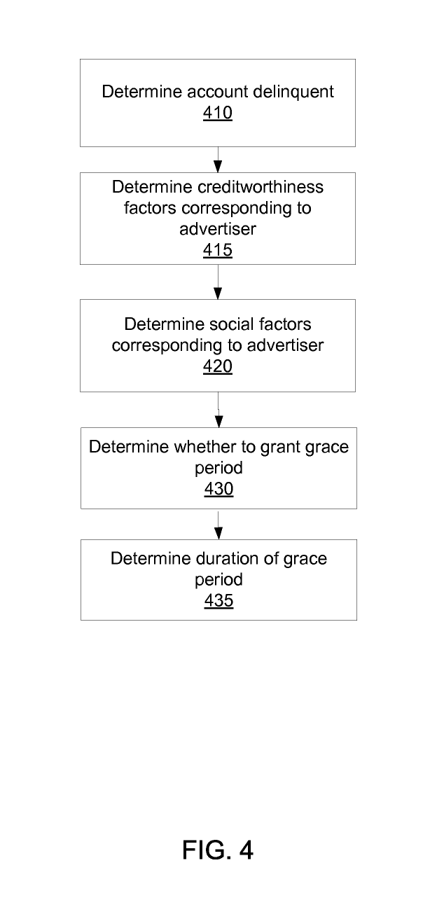

The social networking system determines 315 whether or not to grant a grace period based on certain factors that can include one or more creditworthiness factors and/or one or more social factors associated with the advertiser and its advertising account. A grace period is a period of time during which the advertising campaign is allowed to continue even though the account associated with the advertiser has an overdue balance. The determination 315 is made prior to suspending the account and uses the factors that are explained in more detail in the context of FIG. 4. If the grace period is not granted 320, then the account of the advertiser is suspended 325. Suspension of an account terminates further advertisement distribution (and any other services provided to the advertiser by the social networking system), prevents the advertiser from managing existing advertisements and campaigns, and prevents the advertiser from adding new advertisements and campaigns.

If the grace period is granted 320 prior to suspension of the account, then the advertiser can be notified 330 of the failed payment and the amount of the overdue balance. Optionally, the advertiser can be notified also of the final date on which the overdue balance must be paid prior to suspension of the account and/or the institution of the grace period. Notifying the advertiser is generally performed through the advertising user interface on the social networking system associated with the advertiser's account. Other methods of alerting the advertiser, such as by email, text, or social networking system objects, are also possible either alone or in combination with the notification in the advertising user interface.

If the payment of the overdue balance is not received 335 before expiration of the grace period then the advertiser's account is suspended 340 (or, alternatively the grace period can be extended), as described above. If, however, payment of the overdue balance is received before the end of the (first or extended) grace period, the advertiser can be notified 345 of the good standing of the account. Because the advertiser's account retains full functionality during the grace period, no changes to the account are needed other than to notify the advertiser that the grace period has been removed and/or that the account is in good standing. Payment can be received through another charge performed by the social networking system to the credit card during the grace period, by a bank transfer initiated by the advertiser, or by another method initiated by either the advertiser or the social networking system.

FIG. 4 is a method flow diagram of a method 400 for determining whether to grant a grace period. In one embodiment, the grace period is a default duration (e.g., 1 day, 2 days, 1 week, 10 days, 1 month, etc.). In another embodiment, the method 400 is used to determine a duration of a grace period. As in the method of FIG. 3, the method 400 starts with a determination 410 that the account is delinquent from an unpaid and overdue balance for advertising services rendered. To determine whether a grace period is granted, the social networking system reviews data corresponding to one or more creditworthiness factors and/or one or more social factors corresponding to the advertiser (or its associated account). One example of a creditworthiness factor is whether funds have been received from the advertiser within a first time period. In some examples, the first time period is seven days. In other examples, the first time period is thirty days. In still other examples, the time period is a multiple (including a multiple of one) of a billing cycle of the social networking system. The time period is generally determined based on empirical data of the service provider (in this case the social networking system) of a time period in which most advertisers (or clients) are likely to pay an overdue balance.

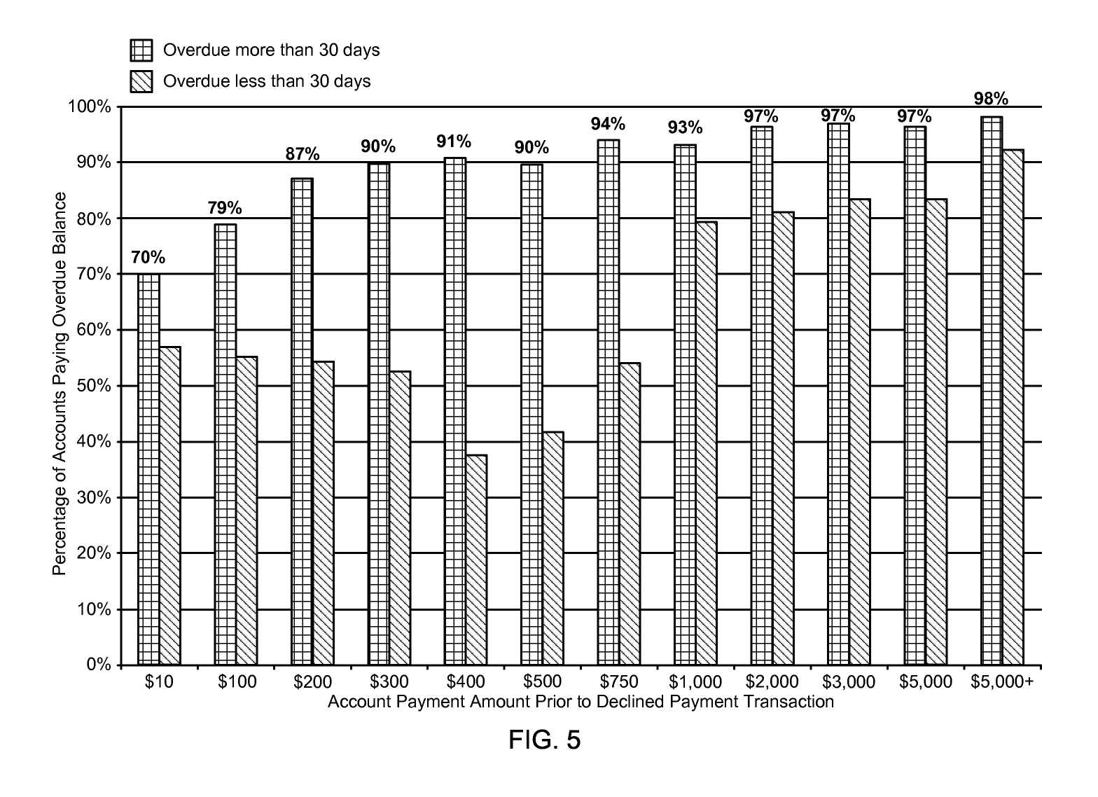

An illustration of such empirical data is shown in FIG. 5. This bar graph indicates the percentage of accounts paid in fewer than 30 days and the percentage of accounts paid in greater than 30 days as a function of account balance. As shown, the rate of payment for accounts due over 30 days is substantially higher than for accounts overdue by fewer than 30 days. The particulars of payment rates will vary depending on the service provider, client base, services provided, and other factors. Regardless, data represented by FIG. 5 can be collected by each service provider and used to determine the precise criteria by which a grace period is granted (e.g., balance and overdue period) and the duration of the grace period is determined.

Returning to the method 400 of FIG. 4, another creditworthiness factor includes a total amount of funds received from an advertiser within a second period. Unlike determining whether any funds have been received within a first time period as described above, this determination takes into account the amount of funds received over a second time period that is not necessarily the same duration as the first time period. Depending on empirical data of the service provider, correlations between the amounts of funds received from a particular party may influence the likelihood that a client with pay an overdue balance associated with their account. In one example, 98% of accounts with balances of less than $500 are paid within seven days. More generally, referring again to FIG. 5, the likelihood that a client will pay a balance overdue less than 30 days drops in the $400-$500 range, climbing steadily until the balance reaches $1000 after which the probability continues a more modest increase. While not shown, it will be appreciated that a long-standing client having provided substantial sums over a long business relationship is more likely to pay an overdue balance than a more recent client having paid only a relatively small amount for services.

Another creditworthiness factor used to determine whether an advertiser is likely to pay an overdue balance is the issuer identification number (“IIN”) (formerly known as the “bank identification number) (“BIN”)) of a credit card (or other payment card number) stored with the social networking system and used for payment of advertising services. The IIN is the first six digits of a payment account card and identifies the financial institution issuing the account. Some institutions may have clients known to be more creditworthy than others. As such, advertisers with cards issued by institutions known or identified as having clients with higher rates of default on debts may not be granted grace periods or granted shorter grace periods.

Social factors corresponding to an advertiser can also be determined 420 as part of the determination regarding whether to grant a grace period (as described in the method 300 of FIG. 3). Social factors include data related to an advertiser (and/or its corresponding advertisements and/or campaign) collected by, for example, a social networking system advertising provider. In principle, advertisers that have an advertising campaign integrated with the social networking system and which successfully drives user engagement are more likely to provide funds to satisfy an overdue balance to avoid an interruption in advertising service.

Advertisers that successfully engage users through social networking system advertising may be more likely to provide payment of an overdue balance because of the measurable success of the advertisements. Specifically, if advertisements have a conversion rate (i.e., an advertisement that results in a purchase) acceptable to the advertiser, are clicked on or interacted with by users, result in an acceptable number of “likes” or referrals to other users, or other similar indication of user engagement, then the value of an advertisement or campaign to the advertiser may be indicative of the likelihood that an advertiser will pay an overdue balance to avoid interruption of service. That is, because the advertiser is successfully reaching users through the social networking system, it may be more likely to avoid an interruption of the advertising services provided by the social networking system.

Another example of a social factor is how connected an ad or advertiser is within the social networking system. Connection to multiple objects in the social networking system suggests that the advertiser is very active in the social networking system. This also suggests a commitment to advertising through the social networking system. For example, whether the advertiser itself has a page within the social networking system is one indication of a social engaged advertiser. The presence of links between the advertisements and the social networking landing page of the advertiser is another indication of an engaged advertiser and of commitment to the advertising campaign or to using the social networking system as an advertising medium because this linkage suggests that the advertiser's landing page is an active advertising tool. Indicators of the quality of the landing page (e.g., visitation rates, number of times a link to the page is shared between users, the number of endorsements or “likes,” and other indications of the rate of user interaction with the landing page (i.e., “page velocity”)) can also be used as an indication that the advertiser will pay an overdue balance.

In still another example, the degree to which an advertiser uses advertising mechanisms specific to the social networking system is another indication that suggests a commitment to social network advertising and that an advertiser is more likely to avoid an interruption in service. For example, the use by the advertiser of social advertisements and sponsored stories, and optionally a corresponding indication of user engagement for these types of advertisement, suggests a commitment to advertising with a social networking system.

In yet another example, the perceived quality of advertisements provided to viewing users through the social networking system is used as an indication of a commitment to advertising with a social networking system. For example, if the advertisements from an advertiser are usually dismissed quickly by users, the advertiser may not be successfully reaching users and may be more inclined not to pay for advertising services rendered. Alternatively, as mentioned above, if the advertisements successfully engage users (as indicated by conversions, clicks, referrals, or other indications or measurements of approval), the advertiser may identify social network advertising as valuable. The various factors mentioned above may also be used in combinations of one or more factors.

These factors are used to determine 430 whether to grant a grace period. In some embodiments, these factors can also be used to determine 435 a duration of the grace period. Generally, the more recently funds have been received, the larger the total amount of funds received, and the stronger the commitment to the advertising campaign (as suggested by the factors above), the more likely an advertiser is to pay an overdue balance. Therefore, it is more likely that a grace period will be granted and the longer the duration of the grace period.

### SUMMARY

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method comprising:
determining that a payment transaction associated with an account of an advertiser for an advertising campaign within a social networking system has been declined;
determining whether to grant a grace period to the advertiser for payment of an overdue balance prior to suspending the account, the grace period comprising a period of time during which the advertising campaign is allowed to continue even though the account associated with the advertiser has the overdue balance, the determining comprising:
determining one or more creditworthiness factors for the advertiser that indicate creditworthiness of the advertiser, and one or more social factors for the advertiser that indicate social activity of the advertiser within the social networking system, and
determining a likelihood that the advertiser will provide the payment of the overdue balance prior to an end of the grace period based on the determined creditworthiness and social factors; and
based on a determination that the advertiser is likely to provide payment prior to the end of the grace period, granting the grace period to the advertiser.

2. The method of claim 1, further comprising either suspending the account for failure of payment of the overdue balance or returning the account to a normal status at the end of the grace period upon payment of the overdue balance.

3. The method of claim 1, further comprising notifying the advertiser of the grace period and a duration of the grace period.

4. The method of claim 3, wherein the duration of the grace period is determined based on at least one of a length of a payment history and an amount of funds received from the advertiser during a first time period.

5. The method of claim 1, further comprising notifying the advertiser of the declined payment transaction and the overdue balance.

6. The method of claim 1, wherein the one or more social factors comprise a plurality of social objects associated with advertisements of the advertiser.

7. The method of claim 1, wherein the one or more social factors comprise at least one link between a landing page associated with the advertiser and at least one advertisement of the advertiser.

8. The method of claim 1, wherein the one or more social factors comprise a conversion rate of advertisements associated with the advertiser.

9. The method of claim 1, wherein the one or more social factors comprise a user dismissal rate of advertisements associated with the advertiser.

10. The method of claim 1, wherein the one or more social factors comprise a user approval rate of advertisements associated with the advertiser.

11. The method of claim 1, wherein the one or more social factors comprise a number of social objects associated with a social networking system landing page associated with the advertiser.

12. The method of claim 1, wherein the one or more creditworthiness factors comprise an issuer identification number of a credit card associated with the advertiser.

13. The method of claim 1, wherein the grace period is granted if the advertiser is determined to have a greater than 75% chance of providing payment during the grace period.

14. A computer program product stored on a computer-readable medium that includes instructions that, when loaded into memory, cause a processor to perform a method, the method comprising:
determining that a payment transaction associated with an account of an advertiser for an advertising campaign within a social networking system has been declined;
determining whether to grant a grace period to the advertiser for payment of an overdue balance prior to suspending the account, the grace period comprising a period of time during which the advertising campaign is allowed to continue even though the account associated with the advertiser has the overdue balance, the determining comprising:
determining one or more creditworthiness factors for the advertiser that indicate creditworthiness of the advertiser, and one or more social factors for the advertiser that indicate social activity of the advertiser within the social networking system, and
determining a likelihood that the advertiser will provide the payment of the overdue balance prior to an end of the grace period based on the determined creditworthiness and social factors; and
based on a determination that the advertiser is likely to provide payment prior to the end of the grace period, granting the grace period to the advertiser.

15. The computer program product of claim 14, further comprising either suspending the account for failure of payment of the overdue balance or returning the account to a normal status at the end of the grace period upon payment of the overdue balance.

16. The computer program product of claim 14, further comprising notifying the advertiser of the grace period and a duration of the grace period.

17. The computer program product of claim 16, wherein the duration of the grace period is determined based on at least one of a length of a payment history, an amount of funds received from the advertiser during a first time period.

18. The computer program product of claim 14, wherein determining whether to grant the grace period is based on the plurality of objects associated with advertisements of the advertiser.

19. The computer program product of claim 14, wherein the one or more social factors comprise links between a landing page and at least one advertisement.

20. The computer program product of claim 14, wherein the one or more social factors comprise a conversion rate of advertisements associated with the advertiser.

22. The computer program product of claim 14, wherein the one or more social factors comprise a user dismissal rate of advertisements associated with the advertiser.

22. The computer program product of claim 14, wherein the one or more social factors comprise a user approval rate of advertisements associated with the advertiser.

23. The computer program product of claim 14, wherein the one or more social factors comprise a number of social objects associated with a social networking system landing page associated with the advertiser.

24. The computer program product of claim 14, wherein the one or more creditworthiness factors comprise an issuer identification number of a credit card associated with the advertiser.

25. The method of claim 14, wherein the grace period is granted for a likelihood greater than 75%.

26. A method comprising:
determining that a payment transaction associated with an account of an advertiser for an advertising campaign has been declined;
determining whether to grant a grace period to the advertiser for payment of an overdue balance prior to suspending the account, the grace period comprising a duration of time during which the advertising campaign is allowed to continue even though the account associated with the advertiser has an overdue balance, the determining comprising:
determining a plurality of factors for the advertiser that indicate the creditworthiness of the advertiser, one of the factors comprising funds received from the advertiser preceding the declined payment transaction, and
determining a likelihood that the advertiser will provide the payment of the overdue balance prior to an end of the grace period based on the determined factors; and
based on a determination that the advertiser is likely to provide payment prior to the end of the grace period, granting the grace period to the advertiser.

27. The method of claim 26, wherein the creditworthiness factors comprise an issuer identification number of a credit card associated with the advertiser.

28. The method of claim 26, wherein the creditworthiness factors comprise a length of a payment history associated with the advertiser.

29. The method of claim 26, wherein the creditworthiness factors comprise an average account balance preceding the declined payment transaction.
